(19) United States
(12) Patent Application Publication
(10) Pub. No.: US 2018/0342005 A1
(43) Pub. Date: Nov. 29, 2018

(54) Place recommendation device and place recommendation method

(71) Applicant: Honda Motor Co., Ltd., Tokyo (JP)

(72) Inventors: Hiromitsu Yuhara, Tokyo (JP); Keiichi Takikawa, Tokyo (JP); Eisuke Soma, Saitama (JP); Shinichiro Goto, Saitama (JP); Satoshi Imaizumi, Saitama (JP)

(73) Assignee: Honda Motor Co., Ltd., Tokyo (JP)

(21) Appl. No.: 15/989,211

(22) Filed: May 25, 2018

(30) Foreign Application Priority Data
May 25, 2017 (JP) 2017-103986

(51) Int. Cl. G06Q 30/06; H04W 4/48

(52) U.S. Cl. CPC G06Q 30/0631; H04W 4/48

(57) ABSTRACT

The disclosure provides a place recommendation device and method, so that even if the device is used by a new user or multiple users, a place that can cause a change in the emotion of the user currently using the device can be recommended. The place recommendation device includes a place information storage part, storing place information that associates with an attribute of an object vehicle, one or more places, and an emotion of an object user; a place identification part, identifying a place based on the place information, wherein the place corresponds to the attribute of the object vehicle and an estimated emotion of the object user; and an output control part, outputting information representing the identified place to the output part.

### CROSS-REFERENCE TO RELATED APPLICATION

This application claims the priority benefit of Japan application serial no. 2017-103986, filed on May 25, 2017. The entirety of the above-mentioned patent application is hereby incorporated by reference herein and made a part of this specification.

### BACKGROUND

### Field of the Disclosure

The present disclosure relates to a device for communicating with a vehicle driver.

### Description of Related Art

Technologies for recommending a place according to a user's emotion already exist.

For example, Patent Document 1 (WO2014/076862A1) discloses a device that estimates the current mood of a user based on behaviour history of the user and determines a place to be recommended to the user by using the estimated mood as a selection condition for the recommended place.

The device set forth in Patent Document 1 is based on the fact that the mood of the user is greatly affected by previous actions of the user, for example, the user who has been working overtime for a long time will feel very tired. In other words, the device set forth in Patent Document 1 is based on a prerequisite that a user has been using a device for a sufficiently long time.

Therefore, cases such as that a user bought a new device and has just started to use this device or a vehicle equipped with a device provides a lease service and may be used by multiple users do not meet the prerequisite required by the device set forth in Patent Document 1, and the device set forth in Patent Document 1 cannot be used to recommend a place.

Therefore, the disclosure is to provide a place recommendation device and a place recommendation method, so that even if the device is used by a new user or the device is used by multiple users, a place that can cause a change in the emotion of the user currently using the device can be recommended.

### SUMMARY

In one embodiment, the place recommendation device includes an output part, outputting information; a vehicle attribute identification part, identifying an attribute of an object vehicle; an emotion estimation part, estimating an emotion of an object user of the object vehicle; a place information storage part, storing place information that associates with the attribute of the vehicle, one or more places, and the emotion of the user; a place identification part, identifying a place based on the place information stored in the place information storage part, wherein the place corresponds to the attribute of the object vehicle identified by the vehicle attribute identification part and the emotion of the object user estimated by the emotion estimation part; and an output control part, outputting information representing the identified place to the output part.

In another embodiment, a place recommendation method is provided and executed by a computer that includes an output part, outputting information; and a place information storage part, storing place information that associates with an attribute of an object vehicle, one or more places, and an emotion of an object user. The method comprises identifying the attribute of the vehicle; estimating the emotion of the object user of the object vehicle; identifying a place based on the place information stored in the place information storage part, in which the place corresponds to the identified attribute of the object vehicle and the estimated emotion of the object user; and outputting info nation indicating the identified place to the output part.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic configuration diagram of a basic system.

FIG. 2 is a schematic configuration diagram of an agent device.

FIG. 3 is a schematic configuration diagram of a mobile terminal device.

FIG. 4 is a schematic diagram of place information.

FIG. 5 is a flowchart of place identification process.

FIG. 6 is a flowchart of place information storage process.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

(Configuration of Basic System)

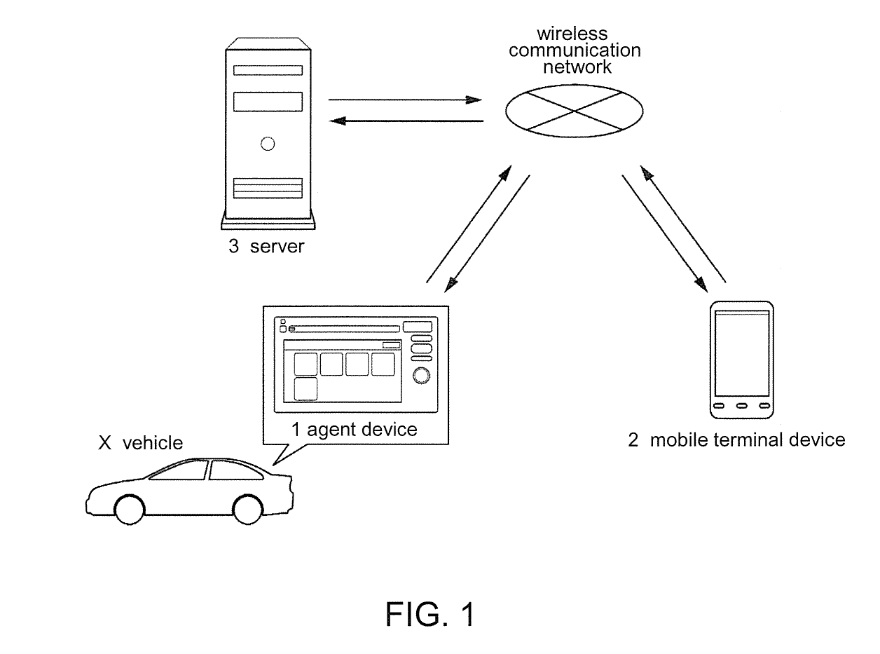

A basic system shown in FIG. 1 includes an agent device 1 mounted on an object vehicle X (moving object), a mobile terminal device 2 (for example, a smart phone) that can be carried into the object vehicle X by a driver, and a server 3. The agent device 1, the mobile terminal device 2 and the server 3 can wirelessly communicate with each other through a wireless communications network (for example, internet). The agent device 1 and the mobile terminal device 2 can wirelessly communicate with each other by near field communication (for example, Bluetooth (“Bluetooth” is a registered trademark)) when they are physically close to each other, for example, coexist in the space of the same object vehicle X.

(Configuration of Agent Device)

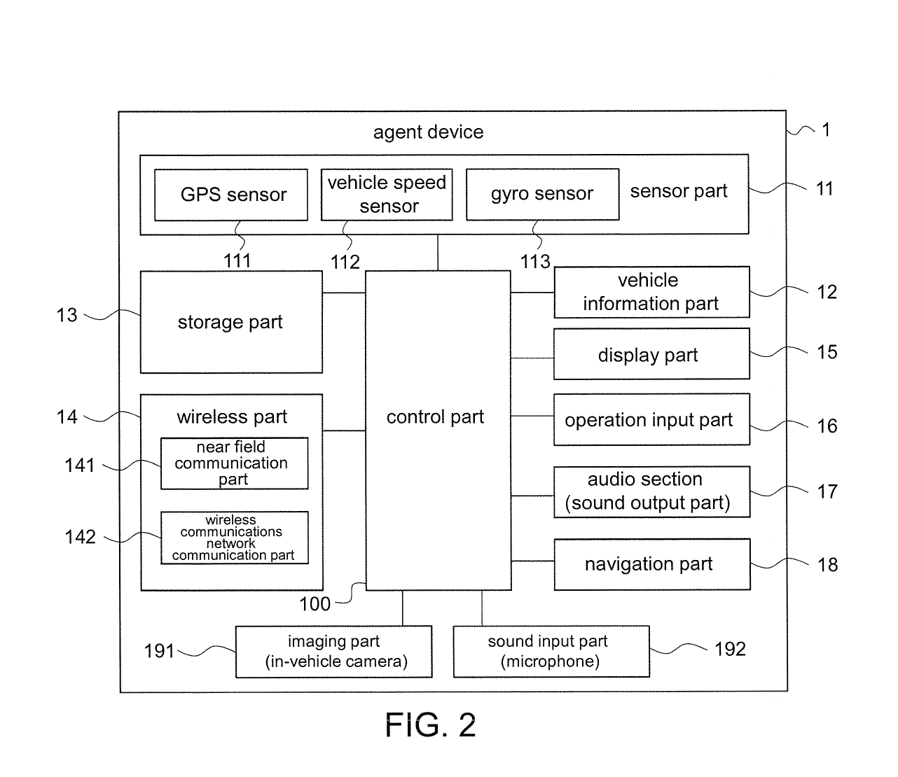

For example, as shown in FIG. 2, the agent device 1 includes a control part 100, a sensor part 11 (including a GPS sensor 111, a vehicle speed sensor 112 and a gyro sensor 113), a vehicle information part 12, a storage part 13, a wireless part 14 (including a near field communication part 141 and a wireless communications network communication part 142), a display part 15, an operation input part 16, an audio part 17 (sound output part), a navigation part 18, a video recording part 191 (in-vehicle camera), and a sound input part 192 (microphone). The agent device 1 is equivalent to an example of “the place recommendation device” of the disclosure. The display part 15 and the audio part 17 are each equivalent to an example of “the output part” of the disclosure. The operation input part 16 and the sound input part 192 are each equivalent to an example of “the input part” of the disclosure. The control part 100 functions as “the vehicle attribute identification part”, “the emotion estimation part”, “the place identification part”, “the output control part”, and “the questioning part” of the disclosure by executing the following operations. In addition, the agent device 1 does not need to include all components of the place recommendation device 1, and the agent device 1 may also functions as a component of the place recommendation device 1 by making an external server or the like to execute the required functions through communication.

The GPS sensor 111 of the sensor part 11 calculates the current location based on a signal from a GPS (Global Positioning System) satellite. The vehicle speed sensor 112 calculates the speed of the object vehicle based on a pulse signal from a rotating shaft. The gyro sensor 113 detects an angular velocity. By the GPS sensor 111, the vehicle speed sensor 112 and the gyro sensor 113, the current location and the heading direction of the object vehicle can be accurately calculated. In addition, the GPS sensor 111 may also obtain information that indicates current date and time from the GPS satellite.

The vehicle information part 12 obtains the vehicle information through an in-vehicle network such as CAN-BUS. The vehicle information includes information such as ON/OFF of an ignition switch and an operation status of a safety device system (ADAS, ABS, air bag, etc.). The operation input part 16 not only can detect input of an operation such as pressing on a switch, but also can detect input of an amount of operation on steering, accelerator pedal or brake pedal, as well as operations on the vehicle window and air conditioning (temperature setting, etc.) that can be used to estimate the emotion of the driver.

The near field communication part 141 of the wireless part 14 is a communication part, for example a Wi-Fi (Wireless Fidelity) (registered trademark), a Bluetooth (registered trademark) or the like, and the wireless communications network communication part 142 is a communication part connecting to a wireless communication network, which is typically a mobile phone network such as 3G, cellular, or LTE communication.

(Configuration of Mobile Terminal Device)

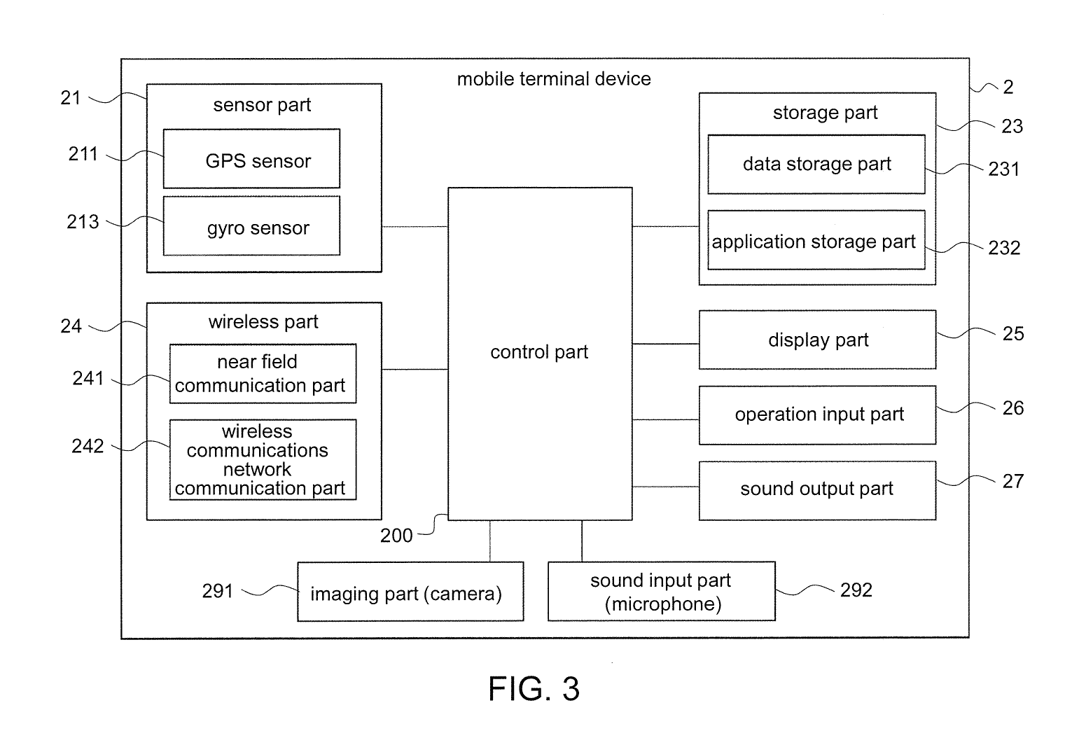

For example, as shown in FIG. 3, the mobile terminal device 2 includes a control part 200, a sensor part 21 (including a GPS sensor 211 and a gyro sensor 213), a storage part 23 (including a data storage part 231 and an application storage part 232), a wireless part 24 (including a near field communication part 241 and a wireless communications network communication part 242), a display part 25, an operation input part 26, a sound output part 27, an imaging part 291 (camera), and a sound input part 292 (microphone). The mobile terminal device 2 may also function as “the place recommendation device” of the disclosure. In this case, the display part 25 and the sound output part 27 are respectively equivalent to an example of “the output part” of the disclosure. The operation input part 26 and the sound input part 292 are respectively equivalent to an example of “the input part” of the disclosure. The control part 200 can function as “the vehicle attribute identification part”, “the emotion estimation part”, “the place identification part”, “the output control part”, and “the questioning part” of the disclosure.

The mobile terminal device 2 has the same components as the agent device 1. Although the mobile terminal device 2 does include a component (the vehicle information part 12 as shown in FIG. 2) for obtaining the vehicle information, the vehicle information can be obtained from the agent device 1 by, for example, the near field communication part 241. In addition, the mobile terminal device 2 may also have the same functions as the audio part 17 and the navigation part 18 of the agent device 1 according to applications (software) stored in the application storage part 232.

(Configuration of Server)

The server 3 may be configured to include one or more computers. The server 3 is configured in a manner of receiving data and a request from each agent device 1 or the mobile terminal device 2, storing the data to a database or other storage part, performing process according to the request, and transmitting a processed result to the agent device 1 or the mobile terminal device 2.

A portion or all of the computers composing the server 3 may be configured to include the components of mobile stations, for example, one or more agent devices 1 or mobile terminal devices 2.

“be configured to” in a manner in which a component of the disclosure executes corresponding operation processing refers to “programming” or “designing” in such a manner that an operation processing device such as a CPU that forms the component reads required information and software from a memory such as a ROM or a RAM or a recording medium, and then executes operation process on the information according to the software. Each component may include the same processor (operation processing device), or each component may be configured to include multiple processors that can communicate with each other.

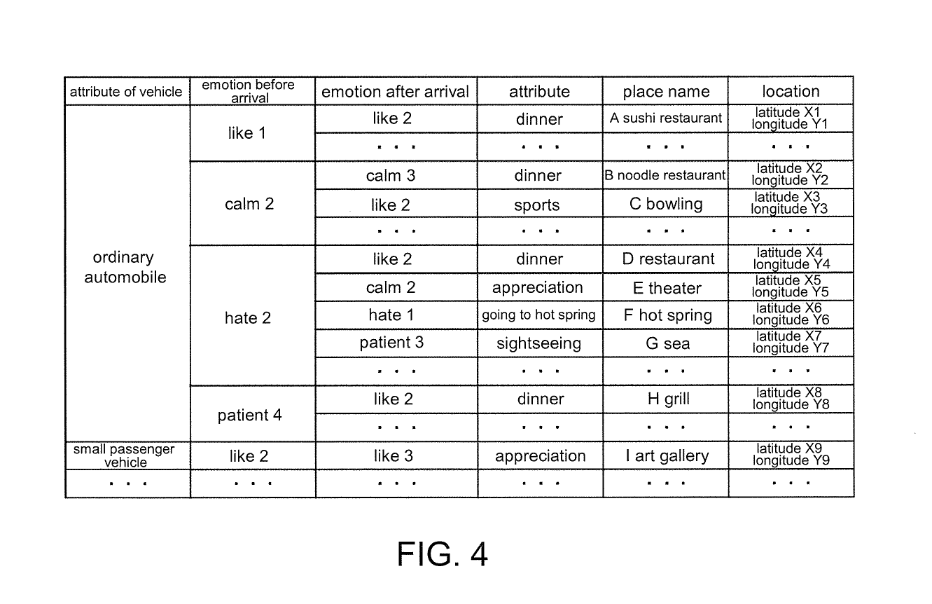

As shown in FIG. 4, the server 3 stores a table in which the attribute of the vehicle, information indicating an emotion of the driver estimated before arriving the place, information indicating an emotion of the driver estimated after arriving the place, the attribute of the place, the place name, and the location are associated. The table is equivalent to an example of “the place information”, “the first place information”, and “the second place information” of the disclosure. In addition, the server 3 where the table is stored is equivalent to an example of “the place information storage part” of the disclosure. In addition, the attribute of the place is equivalent to an example of “the attribute of the place” of the disclosure. The table may also be transmitted to the agent device 1 through communication and stored to the storage part 13 of the agent device 1.

“The attribute of the vehicle” in this specification represents the category of the vehicle. In this embodiment, the phrase “the attribute of the vehicle” refers to “an ordinary passenger vehicle” or “a small passenger vehicle” which is classified according to the structure and size of the vehicle. Alternatively or additionally, a category made by the vehicle name, or a category or specification made by the vehicle name the vehicle color may be used as “the attribute of the vehicle”.

The information indicating the emotion includes: classifications of emotions such as like, calm, hate, and patient; and intensity, represented by an integer, and used for representing weakness/strength of the emotion. The classification of the emotion at least includes positive emotions such as like and calm, and negative emotions such as hate and patient. In addition, emotion estimation process will be described below. The positive emotion is equivalent to an example of “the first emotion” of the disclosure. The negative emotion is equivalent to an example of “the second emotion” of the disclosure.

The attribute of the place is classified according to things that the driver can do after arriving at the place, for example, dinner, sports, appreciation, going to hot spring, or sightseeing. Alternatively or additionally, the place can be classified according to the classification of facilities at the place, the name of the region to which the place belongs, the degree of crowdedness, the topography or the like.

The place name is the name of the place or the name of a facility at the place. Alternatively or additionally, the place name may include the address of the place.

The location is the location of the place which, as shown in FIG. 4, is represented using, for example, latitude and longitude.

The server 3 may further store an impression of the arrivals, a description of the place, and so on.

(Place Identification Process)

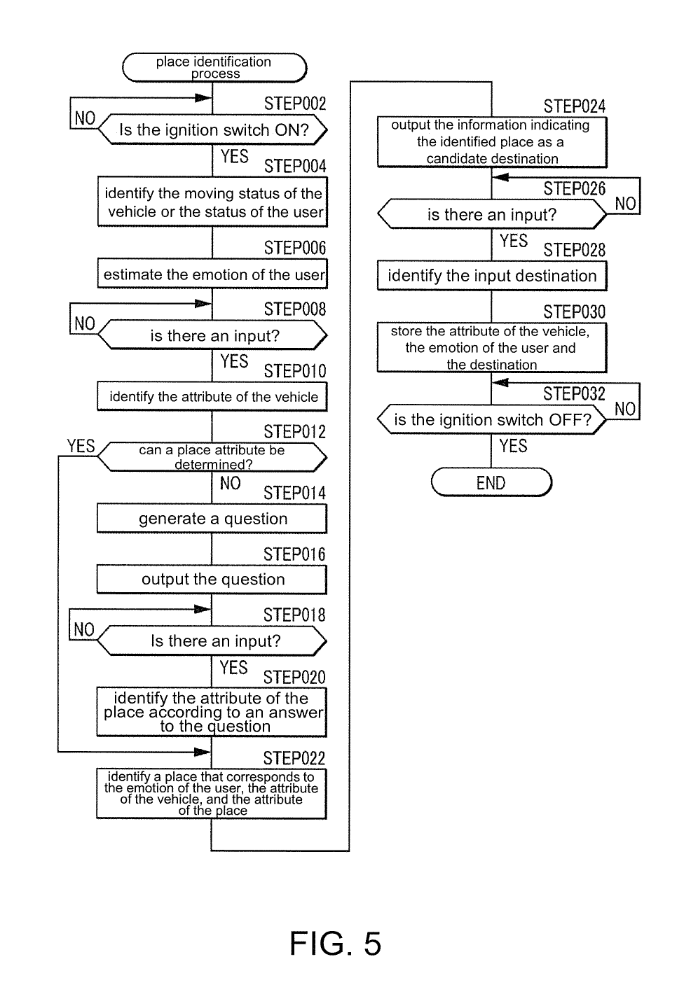

Next, referring to FIG. 5, a place identification process is described.

In this embodiment, it explains that the place identification process is executed by the agent device 1. Alternatively or additionally, the place identification process may be executed by the mobile terminal device 2.

The control part 100 of the agent device 1 determines whether the ignition switch is ON or not based on information obtained by the vehicle information part 12 (FIG. 5/STEP 002).

If the determination result is no (FIG. 5/STEP 002, NO), the control part 100 executes the process of STEP 002.

If the determination result is yes (YES at STEP 002, FIG. 5), the control part 100 identifies one or both of a moving status of the object vehicle X and a status of the object user (i.e., the user of the object vehicle X) based on at least one of information obtained by the sensor part 11, an operation detected by the operation input part 16, an image captured by the imaging part 191, a sound detected by the sound input part 192, and body information of the user obtained from a wearable sensor (not shown) that the object user wears (STEP 004, FIG. 5). In addition, the control part 100 stores time-series data of one or both of the identified moving status of the object vehicle X and the identified status of the object user to the storage part 13.

For example, the control part 100 identifies the moving status of the object vehicle X, for example, a time-series location, a speed of the object vehicle X, and a moving direction of the object vehicle X, based on information obtained by the sensor part 11.

In addition, for example, the control part 100 identifies the status of the object user, for example, an answer to a questionnaire such as “how are you feeling now?”, based on an operation detected by the operation input part 16.

In addition, for example, the control part 100 identifies the status of the object user, for example, a facial expression and behaviour of the object user, based on an image captured by the video recording part 191.

In addition, for example, the control part 100 identifies the status of the object user, for example, speech content and a pitch during speech of the object user, based on a sound detected by the sound input part 192.

In addition, for example, the control part 100 identifies vital information (electromyogram, pulse, blood pressure, blood oxygen concentration, body temperature, etc.) received from a wearable device that the object user wears.

The control part 100 estimates the emotion of the object user based on one or both of the moving status of the object vehicle X and the status of the object user (STEP 006, FIG. 5).

For example, the control part 100 may also estimate the emotion of the object user based on one or both of the moving status of the object vehicle X and the status of the object user according to a preset rule. As described above, the emotion is represented by the classification of the emotions and the intensity representing weakness/strength of the emotion.

For example, if the speed of the object vehicle X is in a state of being not less than a specified speed for more than a specified time, the control part 100 may estimate that the classification of the emotion of the object user is a positive emotion, for example, like. In addition, if the speed of the object vehicle X is in a state of being less than a specified speed for more than a specified time, or if the speed of the object vehicle X frequently increases or decreases within a short period of time, the control part 100 may estimate that the classification of the emotion of the object user is a negative emotion, for example, hate.

In addition, the control part 100 may also execute process in the following manner: the longer the above states last, the higher the estimated intensity value of the emotion of the object user will be.

In addition, the control part 100 may also estimate the emotion of the object user based on, for example, an answer to a questionnaire. For example, if the answer to the questionnaire is “very calm”, the control part 100 may estimate that the classification of the emotion of the object user is a positive emotion “calm” and estimate a high value (for example, 3) for the intensity of the emotion of the object user. If the answer to the questionnaire is “a little bit anxious”, the control part 100 may estimate that the classification of the emotion of the object user is a negative emotion “hate” and estimate a low value (for example, 1) for the intensity of the emotion of the object user.

In addition, the control part 100 may also estimate the emotion of the object user based on the facial expression of the object user. For example, when it determines through image analysis that the object user makes a facial expression such as smile, the control part 100 may estimate that the classification of the emotion of the object user is a positive emotion “like”, and estimate a high value (for example, 5) for the intensity of the emotion of the object user. In addition, for example, if the control part 100 determines through image analysis that the object user makes a facial expression such as depressed, the control part 100 may estimate that the classification of the emotion of the object user is a negative emotion “hate”, and estimate a small value (for example, 2) for the intensity of the emotion of the object user. Alternatively or additionally, the control part 100 may also add the direction of the eyes or the face of the object user to estimate the emotion of the object user.

In addition, the control part 100 may also estimate the emotion of the object user based on the behaviour of the object user. For example, if the control part 100 determines through image analysis that the object user almost has no action, the control part 100 may estimate that the classification of the emotion of the object user is a positive emotion “calm”, and estimate a small value (for example, 2) for the intensity of the emotion. In addition, for example, if the control part 100 determines through image analysis that the object user moves anxiously, the control part 100 may estimate that the classification of the emotion of the object user is a negative emotion “hate”, and estimate a large value (for example, 4) for the intensity of the emotion.

In addition, the control part 100 may also estimate the emotion of the object user based on the speech content of the object user. For example, if the control part 100 determines through sound analysis that the speech content of the object user is positive content such as appraisal or expectation, the control part 100 may estimate that the emotion of the object user is a positive emotion “like”, and estimate a small value (for example, 1) for the intensity of the emotion of the object user. For example, if the control part 100 determines through sound analysis that the speech content of the object user is positive content such as complaint, the control part 100 may estimate that the emotion of the object user is a negative emotion “hate”, and estimate a large value (for example, 5) for the intensity of the emotion of the object user. In addition, if the speech content of the object user includes a particular keyword (such as “so good”, “amazing”, etc.), the control part 100 may estimate that the emotion of the object user is an emotion classification, which is associated with the keyword, with an emotion intensity.

In addition, the control part 100 may also estimate the emotion of the object user based on the pitch of the object user during speech. For example, if the pitch of the object user during speech is equal to or higher than a specified pitch, the control part 100 may estimate that the emotion of the object user is a positive emotion “like”, and estimate a large value (for example, 5) for the intensity of the emotion of the object user. If the pitch of the object user during speech is lower than the specified height, the control part 100 may estimate that the emotion of the object user is a negative emotion “patient”, and estimate a moderate value (for example, 3) for the intensity of the emotion of the object user.

In addition, the control part 100 may also estimate the emotion of the object user by using the vital information (electromyogram, pulse, blood pressure, blood oxygen concentration, body temperature, etc.) from the wearable device that the object user wears.

In addition, for example, the control part 100 may also estimate the emotion of the object user by using an emotion engine based on the moving status of the object vehicle X and the status of the object user. The emotion engine outputs the emotion of the object user from the moving status of the object vehicle X and the status of the object user that are generated by machine learning.

In addition, for example, the control part 100 may also estimate the emotion of the object user with reference to a preset table and based on the moving status of the object vehicle X and the status of the object user.

The control part 100 may also estimate the emotion of the object user by using a combination of the above manners.

The control part 100 determines whether the operation input part 16 or the sound input part 192 detects an input of the object user (an operation of the object user or a sound of the object user) (STEP 008, FIG. 5). Before STEP 008, or if no input of the object user is detected within a fixed period of time, the control part 100 may output information through the display part 15 or the audio part 17 to urge the object user to input the attribute of the object vehicle X.

If the determination result is no (NO at STEP 008, FIG.5), the control part 100 executes the process of STEP 008 again.

If the determination result is yes (YES at STEP 008, FIG. 5), the control part 100 identifies the attribute of the object vehicle X (STEP 010, FIG.5). Alternatively or additionally, the control part 100 may identify a pre-stored attribute of the object vehicle X, or may communicate with the object vehicle X or other external device to identify the attribute of the object vehicle X.

The control part 100 determines whether an attribute of a candidate place to be recommended to the object vehicle X can be specified from the attribute of the object vehicle X and the estimated emotion of the object user (STEP 012, FIG. 5).

For example, the control part 100 refers to a correspondence table (not shown) to determine whether there is attribute of the place associated with the attribute of the object vehicle X and the estimated emotion of the object user. For example, the control part 100 refers to information associated with the attribute of the object vehicle X, emotions of the object user or other users, and attributes of places where the object user or other users have been to determine whether an attribute of the place can be determined or not.

If the determination result is no (NO at STEP 012, FIG. 5), the control part 100 generates a question about desire for action of the object user (STEP 014, FIG. 5). For example, if the current time obtained from the GPS sensor 111 indicates a time period suitable for having dinner, the control part 100 may generate a question such as “Are you hungry?”. In addition, for example, when receiving information that a new movie is being be released through a network, the control part 100 may generate a question such as “A new movie is being released. Are you interested?”. In addition, for example, when acquiring information that indicates a location (for example, sea) in a remark of a friend of the object user from an SNS (Social Networking Services) site through a network, the control part 100 may generate a question such as “Your friend xx says about the sea. Are you interested in the sea?”.

The control part 100 may also obtain a word list for generating questions from the server 3 through communication or refer to a word list for generating questions that is stored in the storage part 13.

The control part 100 outputs the generated question to the display part 15 or the audio part 17 (STEP 016, FIG. 5). The control part 100 may select a question according to a specified rule, for example, a question in preset questions that matches the current date and time, and output the question to the display part 15 or the audio part 17.

The control part 100 determines whether the operation input part 16 or the sound input part 192 detects an input of the object user (an operation of the object user or a sound of the object user) (STEP 018, FIG. 5).

If the determination result is no (NO at STEP 018, FIG. 5), the control part 100 executes process of STEP 018.

If the determination result is yes (YES at STEP 018, FIG. 5), the control part 100 identifies the attribute of the place based on an answer to the question (STEP 020, FIG. 5).

After STEP 020 (FIG. 5) or if the determination result of STEP 012 (FIG. 5) is yes (YES at STEP 012, FIG. 5), the control part 100 identifies a place that corresponds to the emotion of the object user, the attribute of the object vehicle X, and the attribute of the place (STEP 022, FIG. 5).

For example, the control part 100 obtains the table shown in FIG. 4 from the server 3 through a network, and refers to the table to identify the place that corresponds the emotion of the object user, the attribute of the object vehicle X, and the attribute of the place.

For example, the control part 100 identifies a place that satisfies the following conditions: the emotion before arrival coincides with the emotion of the object user, the attribute of the vehicle coincides with the attribute of the object vehicle X, and, the intensity of the emotion after arrival is the highest among places of the genre corresponding to the answer to the question. For example, when the classification of the emotion of the object user is “hate”, the intensity of the emotion of the object user is 2, the attribute of the object vehicle X is “ordinary automobile”, and the answer to the question “Are you hungry?” is “Yes”, the control part 100 identifies a restaurant D from the table of FIG. 4.

In addition, the control part 100 may also use an engine to identify the attribute of the place based on a question generated by machine learning and an answer to the question. In addition, the control part 100 may also associate with in advance a question and an attribute of a place that corresponds to an answer to the question.

In addition, the control part 100 may also transmit information indicating the emotion of the object user, the attribute of the object vehicle X, and the attribute of the place to the server 3 through a network, and then receive from the server 3 the place that corresponds to the emotion of the object user, the attribute of the object vehicle X, and the attribute of the place.

If multiple places are identified, the control part 100 may identify the place closest to the location of the object vehicle X obtained from the sensor part 11, or the place that can be reached in the shortest time.

The control part 100 outputs the information indicating the identified place to the display part 15 or the audio part 17 (STEP 024, FIG. 5). The information indicating the identified place is, for example, the information indicating a place name or a place on a map.

The control part 100 determines whether the operation input part 16 or the sound input part 192 detects an input of the object user (an operation of the object user or a sound of the object user) (STEP 026, FIG. 5).

If the determination result is no (NO, at STEP 026, FIG. 5), the control part 100 executes process of STEP 026.

If the determination result is yes (YES at STEP 026, FIG. 5), the control part 100 identifies a destination based on the input of the object user (STEP 028, FIG. 5). The control part 100 may also output the destination to the navigation part 18 to start navigation process toward the destination.

The control part 100 stores the information indicating the attribute of the object vehicle X, the emotion of the object user, and the destination to the storage part 13 (STEP 030, FIG. 5).

The control part 100 determines whether the ignition switch is OFF based on information obtained by the vehicle information part 12 (STEP 032, FIG. 5).

If the determination result is no (NO at STEP 032, FIG. 5), the control part 100 executes process of STEP 032.

If the determination result is yes (YES at STEP 032, FIG. 5), the control part 100 ends the place identification process.

(Place Information Storage Process)

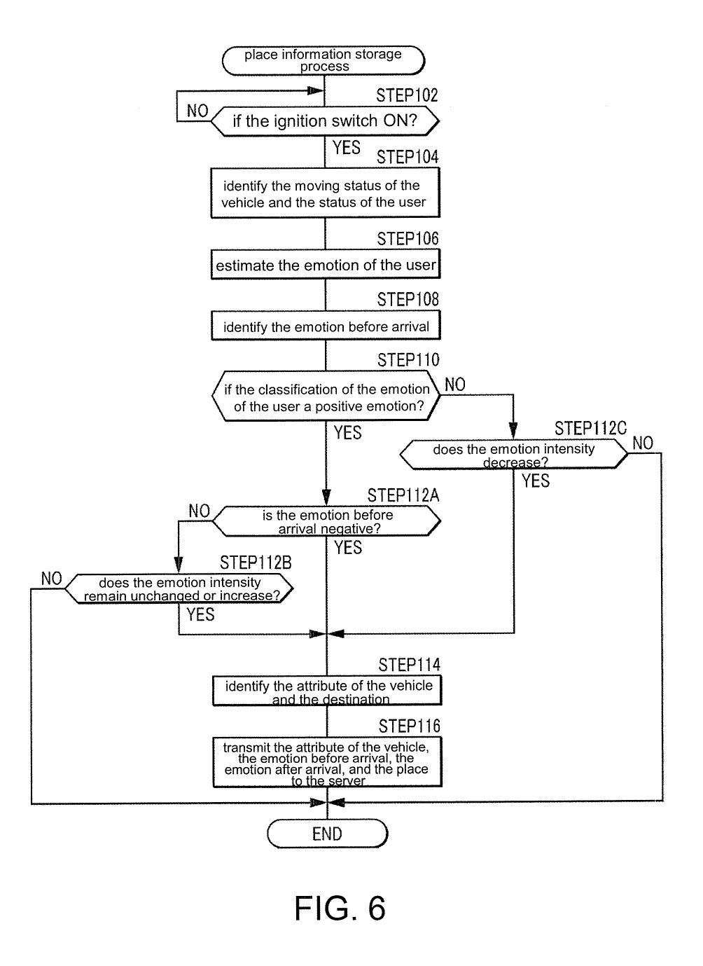

Referring to FIG. 6, place information storage process is described.

The place information storage process is executed after the place identification process that is performed by a device that executes the place identification process in FIG. 5. However, when the information has not been sufficiently gathered, the place information storage process may also be executed independently of the place identification process to collect information.

The control part 100 determines whether the ignition switch is ON based on the information obtained by the vehicle information part 12 (STEP 102, FIG. 6).

If the determination result is no (NO at STEP 102, FIG. 6), the control part 100 executes process of STEP 102.

If the determination result is yes (YES at STEP 102, FIG. 6), the control part 100 identifies one or both of the moving status of the object vehicle X and the status of the object user based on the information obtained by the sensor part 11, an operation detected by the operation input part 16, an image captured by the imaging part 191, and a sound detected by the sound input part 192 (STEP 104, FIG. 6).

The control part 100 estimates the emotion of the object user (hereinafter referred to as “emotion after arrival”) based on one or both of the moving status of the object vehicle X and the status of the object user (STEP 106, FIG. 6).

The control part 100 refers to the storage part 13 to identify the emotion estimated at STEP 006 (FIG. 5) of the place identification process (hereinafter referred to as “emotion before arrival”) (STEP 108, FIG. 6).

The control part 100 determines whether the classification of the emotion of the object user after arrival estimated at STEP 106 (FIG. 6) is a positive emotion (STEP 110, FIG. 6).

If the determination result is yes (YES at STEP 110, FIG. ••YES), the control part 100 determines whether the classification of the emotion of the object user before arrival that is identified at STEP 108 (FIG. 6) is a negative emotion (STEP 112A, FIG. 6).

It should be noted that the determination result of STEP 110 in FIG. 6 being yes means that the classification of the emotion of the object user after arrival is a positive emotion. In STEP 112A in FIG. 6, in other words, the control part 100 determines whether the emotion of the object user changes from a negative emotion to a positive emotion after arriving the place or the emotion of the object user is originally not a negative emotion before arrival.

If the determination result is no (NO at STEP 112A, FIG. 6), it is determined whether the intensity of the emotion of the object user after arrival is equal to or higher than the intensity of the emotion of the object user before arrival (STEP 112B, FIG. 6). It should be noted that the determination result of STEP 112A in FIG. 6 being no means that the classification of the emotions of the object user before and after arrival are both a positive emotion classification. At STEP 112B in FIG. 6, the control part 100 determines whether the intensity of the positive emotion remains unchanged or increases.

If the determination result of STEP 110 in FIG. 6 is no (NO at STEP 110, FIG. 6), the control part 100 determines whether the intensity of the emotion of the object user after arrival is lower than the intensity of the emotion of the object user before arrival (STEP 112B, FIG. 6). It should be noted that the determination result of STEP 110 in FIG. 6 being negative means that the classification of the emotion of the object user after arrival is not a positive emotion classification, that is, the classification of the emotion of the object user after arrival is a negative emotion classification. At STEP 112B in FIG. 6, the control part 100 determines whether the intensity of the negative emotion decreases.

When the determination result of STEP 112A, STEP 112B or STEP 112C in FIG. 6 is yes (YES at STEP 112A, STEP 112B, or STEP 112C, FIG. 6), the control part 100 refers to the storage part 13 to identify the attribute of the object vehicle X and the destination (STEP 114, FIG. 6).

Further, when the determination result of STEP 112A in FIG. 6 is yes, the emotion of the object user is estimated a negative emotion before arriving the place, but changes to a positive emotion after arriving the place.

In addition, when the determination result of STEP 112B in FIG. 6 is yes, the emotions of the object user before and after arriving the place are both a positive emotion and the intensity of the emotion remains unchanged or increases.

In addition, when the determination result of STEP 112C in FIG. 6 is yes, the emotions of the object user before and after arriving the place are both a negative emotion and the intensity of the emotion decreases.

Generally speaking, when the determination result of STEP 112A, STEP 112B or STEP 112C in FIG. 6 is yes, the arriving the place causes a positive change in the emotion of the object user.

Then, the control part 100 transmits the attribute of the object vehicle X, the emotion before arrival, the emotion after arrival, and the place to the server 3 through the network (STEP 116, FIG. 6). After receiving the information, the server 3 refers to the information that associates the place with the place category to identify a category of the received place. Then, the server 3 associates with and stores the identified category of the place and the received information including the attribute of the object vehicle X, the emotion before arrival, the emotion after arrival, and the place, and then updates the table shown in FIG. 4.

After the process of STEP 116 in FIG. 6, or if the determination result of STEP 112B or STEP 112C in FIG. 6 is no (NO at STEP 112B or STEP 112C, FIG. 6), the control part 100 ends the place information storage process.

(Effects of the Embodiment)

According to the agent device 1 having the above configuration, the place that corresponds the attribute of the object vehicle X and the emotion of the object user can be identified based on the place information (STEP 022, FIG. 5).

For example, even though going to a place with nice view, the emotion of the object user after arriving the place may also vary depending on the emotion of the object user before arriving the place.

In addition, even though going to the same place, the emotion of the object user after arriving the place may also vary depending on the attribute of the object vehicle X. For example, when the object user drives an ordinary passenger vehicle capable of moving at a high speed and when the object user drives a small passenger vehicle with easy maneuverability, the emotion of the object user at the place may vary even if the object user stops at the same place.

According to the agent device 1 having the above configuration, as described above, factors affecting the emotion of the object user are taken into consideration and thus the place is identified.

In addition, the information indicating the identified place is outputted to one or both of the display part 15 and the audio part 17 by the control part 100 (STEP 024, FIG. 5).

Therefore, even if the agent device 1 is used by a new user or the agent device 1 is used by multiple users, a place that can cause a change in the emotion of the user currently using the agent device 1 can be recommended.

In addition, according to the agent device 1 having the above configuration, the place is identified by adding the answer to the question (STEP 016 to STEP 022, FIG. 5). Therefore, a more appropriate place can be identified.

According to the agent device 1 having the above configuration, information in which multiple object users are accumulated is added to estimate the emotion of the object user currently using the device (FIG. 4 and STEP 022 in FIG. 5). Therefore, the emotion of the object user can be estimated more precisely.

In addition, according to the agent device 1 having the above configuration, the information, related to the place where the emotion of the object user remains unchanged or changes to a positive emotion, is transmitted and store to the server 3, and identify next and subsequent places based on the information (YES at STEP 110, STEP 112A, STEP 112B and STEP 116 in FIG. 6, and STEP 022 in FIG. 5). Therefore, the place can be properly identified from the point of view of causing the emotion of the object user to remain in or change to a positive emotion (the first emotion).

According to the agent device 1 having the above configuration, the place can be properly identified from the point of view of enhancing the first emotion or weakening the second emotion (YES at STEP 112B or STEP 112C, FIG. 6).

According to the agent device 1 having the above configuration, the information indicating the attribute of the object vehicle X is identified by the input part (STEP 010, FIG. 5). Therefore, even if the agent device 1 is a portable device, the attribute of the object vehicle X can be identified.

According to the agent device 1 having the above configuration, the emotion of the object user is estimated based on the action information, where the action information indicates the action of the object vehicle X that is presumed to indirectly indicate the emotion of the object user (STEP 006 in FIG. 5, STEP 106 in FIG. 6). Therefore, the emotion of the object user can be estimated more precisely. Accordingly, a place that more matches the emotion of the object user can be recommended.

(Modified Embodiment)

The control part 100 may also identify the place that corresponds to the emotion of the object user and the attribute of the object vehicle X by omitting STEP 014 to STEP 018 in FIG. 5.

The information that associates with the emotion of the user, the attribute of the vehicle, the place, and the category of the place may also be, for example, information determined by an administrator of the server 3. In addition, classification may also be made according to the age, gender, and other attributes of each user.

In the embodiments, the emotion is represented by the emotion classification and the emotion intensity, but may also be represented by the emotion classification only or by the emotion intensity only (for example, a higher intensity indicates a more positive emotion, and a lower intensity indicates a more negative emotion).

(Other Description)

In one embodiment, the place recommendation device includes an output part, outputting information; a vehicle attribute identification part, identifying an attribute of an object vehicle; an emotion estimation part, estimating an emotion of an object user of the object vehicle; a place information storage part, storing place information that associates with the attribute of the vehicle, one or more places, and the emotion of the user; a place identification part, identifying a place based on the place information stored in the place information storage part, wherein the place corresponds to the attribute of the object vehicle identified by the vehicle attribute identification part and the emotion of the object user estimated by the emotion estimation part; and an output control part, outputting information representing the identified place to the output part.

According to the place recommendation device having such a composition, a place corresponding to the attribute of the object vehicle and the emotion of the object user is identified based on the place information.

For example, even though going to the destination with nice view, the emotion of the object user after arriving the place may also vary depending on the emotion of the object user before arriving the place.

In addition, even though going to the same place, the emotion of the object user after arriving the place may also vary depending on the attribute of the object vehicle. For example, when the object user drives an ordinary passenger vehicle capable of moving at a high speed and when the object user drives a small passenger vehicle with easy maneuverability, the emotion of the object user at the place may vary even if the object user stops at the same place.

According to the place recommendation device having the above configuration, as described above, factors affecting the emotion of the object user are taken into consideration and thus the place is identified.

In addition, the information indicating the identified place is outputted to output part by the output control part.

Therefore, even if the device is used by a new user or the device is used by multiple users, a place that can cause a change in the emotion of the user currently using the device can be recommended.

In one embodiment, the place recommendation device includes an input part, detecting an input of the object user; and a questioning part, outputting a question through the output part, and identifying an answer to the question, wherein the question is related to desire of the object user, and the answer is detected by the input part and related to the desire of the object user. The place information comprises the attribute of the place, and the place identification part identifies the attribute of the place which coincides with the desire of the object user based on the answer identified by the questioning part, and identifies the place based on the place information, the attribute of the object vehicle, the emotion of the object user, and the attribute of the place which coincides with the desire of the object user.

According to the place recommendation device having the above configuration, the place is identified by adding the answer to the question. Therefore, a more appropriate place can be identified.

In one embodiment, in the above the place recommendation device, the place information is information that accumulating the attribute of the vehicle, the place, an emotion of the user estimated before arriving the place, and an emotion of the user estimated after arriving the place for multiple users.

According to the place recommendation device having the above configuration, information in which multiple users are accumulated is added to estimate the emotion of the object user currently using the device. Therefore, the emotion of the object user can be estimated more precisely.

In another embodiment, the place recommendation device comprises a location identification part, identifying a location of the object vehicle, wherein the place information includes first place information and second place information. The first information associates with attribute of the vehicle, the attribute of the place, and the emotion of the user. The second place information associates with the place, the location of the place, and the attribute of the place. The place identification part refers to the first place information to identify the attribute of the place based on the attribute of the object vehicle and the estimated emotion of the object user, and refers to the second place information to identify the place with based on the location of the object vehicle and the attribute of the place.

If two places are not the same but have a same attribute, it is estimated that the emotions of the user after arriving the places are similar. In view of this, according to the place recommendation device having the above configuration, the attribute of the place is identified by taking the attribute of the object vehicle and the emotion of the object user into consideration, and further the place identified by taking the location of the vehicle into consideration.

Therefore, a place corresponding to the location of the vehicle can be identified among places that cause the emotion of the user to change, and thus the place can be recommended.

In another embodiment, in the above place recommendation device, the emotion of the object user is represented by one or both of a first emotion and a second emotion different from the first emotion, and the place identification part identifies a place where the emotion becomes the first emotion after arrival.

According to the place recommendation device having such a composition, the place can be properly identified from the perspective of causing the emotion of the object user to remain in or change to the first emotion.

In another embodiment, in the above place recommendation device, the emotion of the object user is represented by information comprising an emotion classification and an emotion intensity. The emotion classification is the first emotion or the second emotion different from the first emotion, and the emotion intensity represents an intensity of the emotion. The place identification part identifies a place that causes the emotion to change in such a manner that the intensity of the first emotion increases or the intensity of the second emotion decreases.

According to the place recommendation device having the above configuration, the place can be properly identified from the perspective of enhancing the first emotion or weakening the second emotion.

In another embodiment, in the above place recommendation device comprises an input part, detecting an input of the object user, wherein the vehicle attribute identification part identifies the attribute of the vehicle detected by the input part.

According to the place recommendation device having the above configuration, even if the place recommendation device is a portable device, the information indicating the attribute of the vehicle can be identified by the input part.

In another embodiment, the place recommendation device comprises a sensor part, identifying action information indicating an action of the object vehicle. The emotion estimation part estimates the emotion of the object user based on the action information identified by the sensor part.

According to the place recommendation device having the above configuration, the emotion of the object user is estimated based on the action information, where the action information indicates the action of the object vehicle that is presumed to indirectly indicates the emotion of the object user. Therefore, the emotion of the object user can be estimated more precisely. Accordingly, a place that more matches the emotion of the object user can be recommended.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A place recommendation device, comprising:
an output part, outputting information;
a vehicle attribute identification part, identifying an attribute of a vehicle as an object, i.e., an object vehicle;
an emotion estimation part, estimating an emotion of an object user that is a user of the object vehicle;
a place information storage part, storing place information that associates with attribute of the vehicle, one or more places, and the emotion of the user;
a place identification part, identifying a place based on the place information stored in the place information storage part, wherein the place corresponds to the attribute of the object vehicle identified by the vehicle attribute identification part and the emotion of the object user estimated by the emotion estimation part; and
an output control part, outputting information indicating the identified place to the output part.

2. The place recommendation device according to claim 1, comprising:
an input part, detecting an input of the object user; and
a questioning part, outputting a question through the output part, and identifying an answer to the question, wherein the question is related to desire of the object user, and the answer is detected by the input part and related to the desire of the object user,
wherein the place information comprises an attribute of the place, and
the place identification part identifies the attribute of the place which coincides with the desire of the object user based on the answer identified by the questioning part, and identifies the place based on; the place information, the attribute of the object vehicle, the emotion of the object user, and the attribute of the place which coincides with the hope of the object user.

3. The place recommendation device according to claim 1, wherein
the place information is an information accumulating the attribute of the vehicle, the place, an emotion of the user estimated before arriving the place, and an emotion of the user estimated after arriving the place, for multiple users.

4. The place recommendation device according to claim 1, further comprising a location identification part, identifying a location of the object vehicle,
wherein the place information comprises first place information and second place information,
the first place information associates with the attribute of the vehicle, the attribute of the place, and the emotion of the user,
the second place information associates with the place, the location of the place, and the attribute of the place, and
the place identification part refers to the first place information to identify the attribute of the place based on the attribute of the object vehicle and the estimated emotion of the object user, and refers to the second place information to identify the place based on a location of the object vehicle and the attribute of the place.

5. The place recommendation device according to claim 1, wherein
the emotion of the object user is represented by one or both of a first emotion and a second emotion different from the first emotion, and
the place identification part identifies a place where the emotion becomes the first emotion after arrival.

6. The place recommendation device according to claim 1, wherein
the emotion of the object user is represented by information comprising an emotion classification and an emotion intensity, in which the emotion classification is the first emotion or the second emotion different from the first emotion, and the emotion intensity represents an intensity of the emotion; and
the place identification part identifies a place that causes the emotion to change in such a manner that the intensity of the first emotion increases or the intensity of the second emotion decreases.

7. The place recommendation device according to claim 1, further comprising an input part, detecting an input of the object user,
wherein the vehicle attribute identification part identifies the attribute of the vehicle detected by the input part.

8. The place recommendation device according to claim 1, further comprising a sensor part, identifying action information indicating an action of the object vehicle,
wherein the emotion estimation part estimates the emotion of the object user based on the action information identified by the sensor part.

9. A place recommendation method, executed by a computer that includes an output part, outputting information; and a place information storage part, storing place information that associates with an attribute of a vehicle, one or more places, and an emotion of a user, and the method comprising:
identifying the attribute of an object vehicle that is a vehicle as an object;
estimating the emotion of an object user that is a user of the object vehicle;
identifying a place based on the place information stored in the place information storage part, in which the place corresponds to the identified attribute of the object vehicle and the estimated emotion of the object user; and
outputting information indicating the identified place to the output part.
